(19) United States
(12) Patent Application Publication
(10) Pub. No.: US 2009/0090256 A1
(43) Pub. Date: Apr. 9, 2009

(54) Sludge Dewatering System

(76) Inventor: Robert Edward Mealey, JR., Wickliffe, OH (US)

Correspondence Address: ROBERT EDWARD MEALEY, JR., 1900 RUSH ROAD, WICKLIFFE, OH, 44092, US

(21) Appl. No.: 11/866,415

(22) Filed: Oct. 3, 2007

(51) Int. Cl. B30B 9/04

(52) U.S. Cl. 100/126

(57) ABSTRACT

The device of the present invention removes liquid from sludges, such as water from an industrial pretreatment sludge. The device includes a chamber with an inlet for introducing the sludge to be dewatered into the chamber. The device includes a hydraulically driven reciprocating piston which functions as a containment wall at one end of the chamber and as a means to subject the sludge to mechanical pressure for dewatering, with seals sufficient to contain the sludge within the chamber during operation. The device includes a reciprocating end cap which functions as a containment wall at the end of the chamber opposite the reciprocating piston. The end cap includes a micro porous membrane filter assembly for retention of solids, support structure for the filter, a void area for vacuum pump evacuation to assist in dewatering, and an outlet for the liquid displaced from the sludge. At the conclusion of the dewatering process the end cap is retracted and the dewatered sludge is discharged from the chamber by the extension of the reciprocating piston.

### BACKGROUND OF THE INVENTION

The present invention comprises an apparatus and a method for the removal of liquid from sludges, slurries, or suspensions, hereinafter collectively referred to by the generic term “sludge”.

It is well known that in numerous industries sludge is produced as a byproduct of industrial processes. It is often desirable to separate the liquid and solid constituents of the sludge in order to reuse or dispose of the recovered material, be it liquid or solid.

More particular mention may be made in the treatment of sludges produced from the chemical pretreatment of industrial waste streams, as in the printing industry. The waste streams that result from cleaning the ink from printing presses is treated to precipitate and flocculate solid contaminants, the end result being water which can be reused or released to sewer or septic systems and a sludge of, typically, 5% solids and 95% water. The sludge must be dehydrated before it can be disposed of, pursuant to landfill regulations.

In the interest of clarity and convenience I will assume sludge comprised of water and particulate contaminants for the remainder of this application, while acknowledging the sludge may be composed of any number of liquid/solid compositions. The removal of water from sludge is universally referred to, and will be hereinafter, as “dewatering”.

A variety of apparatuses are known whose object it is to effect the dewatering of the aforementioned sludges. These include recessed plate filter presses, both horizontally and vertically oriented, continuous belt presses, screw presses, rotary drum vacuum systems, and thermal dewatering systems, to name a few. Each of these technologies has considerable drawbacks. For example, the horizontally oriented, recessed plate filter press, which is the most popular method in the sludge dewatering industry, is limited by long cycle times (an average of four to eight hours per batch of sludge), limited efficacy (25 to 60% solids percentage depending on the nature of the sludge), contaminated effluent from inefficient sludge capture, and labor intensive cleaning and replacement of filter cloths.

### SUMMARY OF THE INVENTION

The present invention overcomes many of the limitations of the prior art by utilizing compaction pressures in excess of 50 bar in conjunction with a maximum vacuum pressure of less than 0.007 millibar and a novel filter assembly unique in the industry. The invention is comprised of a chamber, with an inlet for admitting the sludge to be dewatered, which functions as a dewatering chamber, a hydraulically driven piston mounted within the chamber, acting as a wall of the chamber and compressing the sludge as it traverses axially along the length of the chamber, and a hydraulically driven end cap abutting the face of the chamber. The end cap functions as a wall of the chamber opposite the piston and contains the filter assembly for retention of the particulate matter. The end cap also contains, behind said filter assembly, a support plate for the filter assembly and a void area evacuated by a vacuum pump for vacuum assist in the dewatering process, an outlet for connection to said vacuum pump, and an outlet for the effluent produced in the dewatering process.

The chamber mentioned above is horizontally oriented and has flanges at each end. The flanges serve to secure the chamber in its mounts and, in the case of the flange at the discharge end of the chamber, as a mating surface for the end cap.

The piston has, preferentially, a groove machined into its circumference for sealing elements. The diameter of the piston, the dimensions of the groove, and the compression chamber walls are machined to close tolerances to provide sealing against leakage to pressures several times those generated internally during a sludge compression cycle. The piston is actuated by the ram of a double acting hydraulic cylinder. Extension of the piston compresses the sludge, driving the water through the filter assembly. At the end of the dewatering cycle the end cap is retracted from the face of the dewatering chamber and the piston is extended to the end of the dewatering chamber, ejecting the dewatered solids into a drum or hopper. To begin the next cycle the end cap is extended to the face of the dewatering chamber and the piston is retracted to the opposite end of the chamber.

The filter assembly mentioned above consists of a circular microfiltration membrane and a circular support screen of equal diameters, the periphery of which are bound and sealed by a rubber gasket. The inside diameter of the filter assembly gasket is equal to the inside diameter of the compression chamber. This gasketed assembly is affixed by an epoxy to a perforated support plate that is part of the end cap. The opposite face of said gasket abuts the face of the compression chamber flange and functions as the primary seal between the compression chamber and the end cap. The filter assembly offers two distinct advantages over the filter cloth used in filter presses. First, the surface of the membrane is flat, as opposed to the textured surface of a filter cloth. This flat surface can not entrap the retained particulate matter like a filter cloth does. For this reason the cake releases cleanly at the end of the dewatering cycle as the end cap is retracted from the compression chamber. In a filter press the cake often needs to be pried off manually or blown off of the surface of the cloth media by compressed air. Second, the pore size of the membrane is equal to or less than the diameter of any particulates that need to be retained. For this reason the membrane will not allow particulates to flow through and contaminate the effluent and, more importantly, the membrane can not become clogged, as the filter cloths in filter presses frequently are.

The end cap serves four primary functions: 1) As the chamber wall opposite the compression piston; 2) As housing and support for the filter assembly; 3) As an evacuation chamber for vacuum dewatering, and; 4) As an outlet for the effluent. The mating surfaces of the compression chamber and end cap are machined to close tolerances and sealed against leakage by the above mentioned gasket and by a sealing element, preferentially an o-ring, which rests in a groove machined into the face of the end cap. The sealing element is of larger diameter than the outside diameter of the gasketed filter assembly. This seal provides protection against leakage at pressures several times those generated internally in the system. The end cap is actuated by the ram of a double acting hydraulic cylinder of equal bore to the hydraulic cylinder which actuates the compression piston. When the ram of the hydraulic cylinder is extended the end cap is pressed against the flange of the compression chamber, sealing the dewatering chamber. At the end of the dewatering cycle the ram of the hydraulic cylinder is retracted, withdrawing the end cap from the compression chamber flange to allow the piston to eject the dewatered solids. The end cap is then extended to the compression chamber prior to the commencement of the next dewatering cycle.

Introduction of the sludge into the compression chamber is controlled by a valve connected to the chamber inlet. At the commencement of each dewatering cycle the valve is opened and the sludge is pumped into the chamber, preferentially by a progressing cavity pump. This valve is then closed and the pump is shut down when the compression chamber is full.

Preferentially, all aspects of system operation are fully automated and controlled by a Programmable Logic Controller, hereinafter referred to as the PLC.

The present invention combines compaction pressures in excess of 50 bar, the microfiltration filter assembly, and near absolute vacuum to dewater the sludge more thoroughly and rapidly than current systems.

### BRIEF DESCRIPTION OF THE DRAWINGS

FIG. 1 is a front elevation view of the preferred embodiment of the invention;

FIG. 2 is a cross-sectional view of the enclosure;

FIG. 3 is a cross-sectional view of the piston and the piston seals;

FIG. 4 is a transverse view of the end cap and filter assembly;

FIG. 5 is a cross-sectional view of the end cap;

FIG. 6 is an enlargement of the upper left hand corner of FIG. 5;

FIGS. 7-10 are cross-sectional views of the enclosure at progressive stages of the dewatering process.

### DESCRIPTION OF THE PREFERRED EMBODIMENT

The present invention is designed to remove the liquid from any number of solid/liquid matrices commonly referred to by the generic term “sludge”. In the interest of clarity I will, for the purposes of this discussion, consider an application where water is removed from sludge, and the invention will hereinafter be referred to as a sludge dewatering system, while acknowledging that the liquid may be of any composition chemically compatible with the wetted parts of the system.

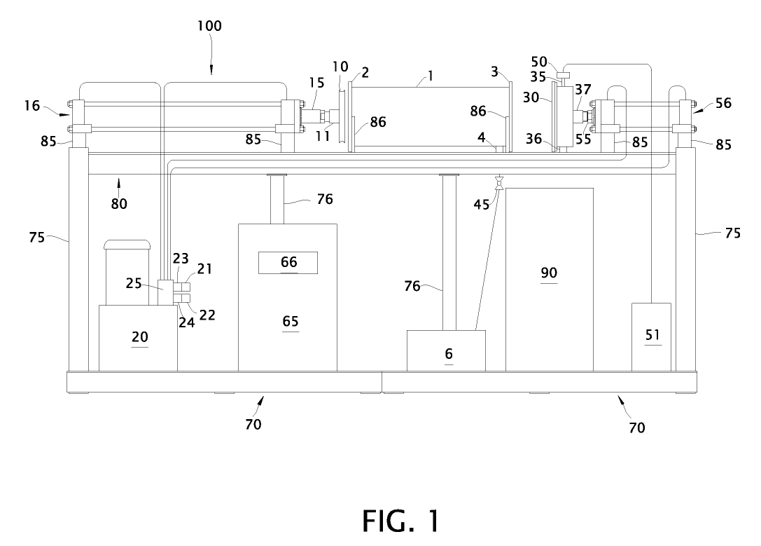

Referring now to FIG. 1, there is shown a sludge dewatering system 100 constructed in accordance with the invention. The invention is comprised of a preferentially horizontally oriented chamber 1, hereinafter referred to as the dewatering chamber, a piston 10 mounted on the end of the ram 15 of a double acting hydraulic cylinder 16, said piston 15 mounted within said chamber 1 and traversing axially along the length of the chamber 1 and acting as a wall of the chamber 1, an end cap 30 mounted on the ram 55 of a second double acting hydraulic cylinder 56 situated opposite the first hydraulic cylinder 16, said end cap 30 also traversing axially in regards to the chamber 1 and abutting the face of the chamber 1 and functioning as a wall of the chamber 1 during the dewatering process, a filter assembly 40 affixed to a support plate 33 within the end cap 30 and serving as the face of the end cap 30 toward the piston 10, a hydraulic power unit 20 and control valves 20, 21 for the operation of hydraulic cylinders 16 and 56, respectively, a vacuum pump 51, an actuated valve 5 for the admittance of the sludge into the chamber 1 through sludge inlet 4, and a Programmable Logic Controller 66 (hereinafter referred to as the PLC 66) for automation and control of system operation.

In the preferred embodiment, the dewatering chamber 1, hydraulic cylinders 16 and 56, piston 10 and end cap 30 are mounted axially on a steel support platform 80. The hydraulic cylinders 16 and 56 are fixedly mounted to support blocks 85 and the dewatering chamber 1 is positioned and restrained from movement along the horizontal axis by support blocks 86. The support platform 80 rests on steel support structures 75 and 76 that elevate the platform above the surface of steel skids 70, which serve as the base of the system 100 and upon which are arranged the hydraulic power unit 20, the vacuum pump 51, a drum 90 for collection of the dewatered solids discharged from the system 100, a progressing cavity pump 6 for transfer of the sludge from, preferentially, an intermediate holding tank into the dewatering chamber 1, and an electrical control and distribution panel 65 which houses the PLC 66 and required system electrical components. The steel support platform 80 has cutouts for the dewatering chamber inlet 4, to which is attached, between the support platform 80 and the progressing cavity pump 6, an electrically actuated high pressure stainless steel ball valve 5, and for the discharge of the dewatered solids from the end of the dewatering chamber 1 into the drum 90.

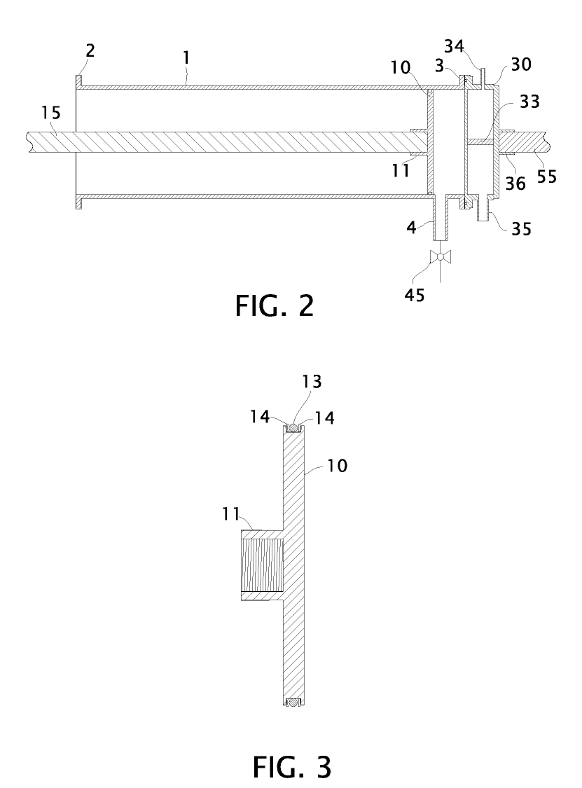

Referring now to FIG. 2, the dewatering chamber 1 is preferentially of stainless steel. The interior of the chamber 1 is machined to meet the mating tolerance requirements of the piston 10/chamber 1 assembly. The dewatering chamber 1 has two flanges 2, 3, one at the end of the chamber 1 nearest the hydraulic cylinder 16 connected to the piston 10 and the other at the opposite end of the dewatering chamber 1, respectively, said flanges 2, 3 restricting lateral movement of the chamber 1 during system operation by contact with the dewatering chamber support blocks 86 mounted on the chamber platform 80. The flange 3 at the discharge end of the dewatering chamber 1 is machined to meet the mating tolerance requirements of the end cap 30. The dewatering chamber 1 has, in proximity to its discharge end, an inlet 4 for the sludge.

The piston 10 is preferentially of stainless steel. The diameter of the piston 10 is determined by the inside diameter of the dewatering chamber 1. The piston 10 is machined to meet the mating tolerance requirements of the piston 10/chamber 1 assembly.

Referring now to FIG. 3, a groove 12 is machined into the circumference of the piston 10 for, preferentially, o-ring 13 and two backup rings 14, one on either side of the o-ring 13. A coupling 111 is integrated into the face of the piston 10 toward the hydraulic cylinder 16 for mounting the piston 10 onto the ram 15 of the hydraulic cylinder 16.

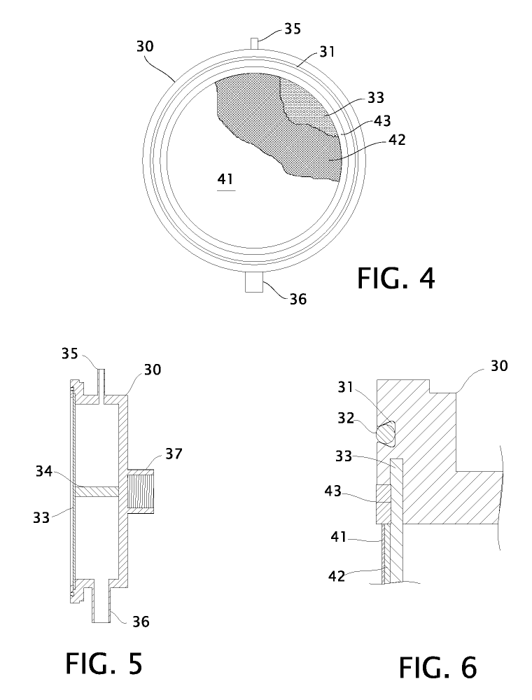

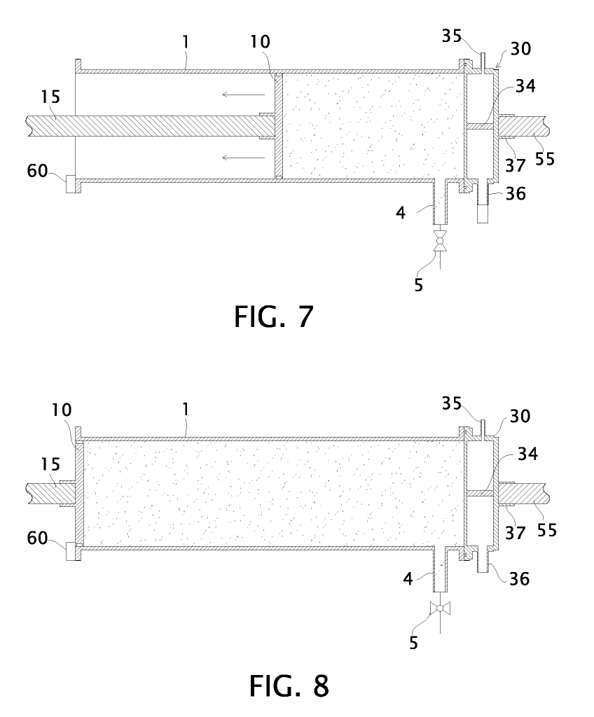

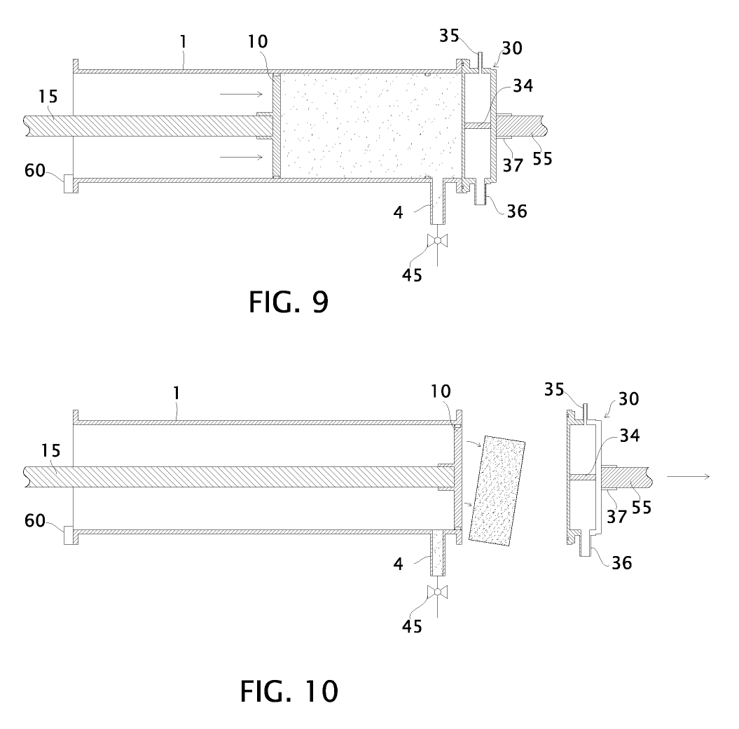

Referring now to FIGS. 4-6, the end cap 30 is preferentially of stainless steel. The face of the end cap 30 toward the dewatering chamber 1 is flanged, the diameter of which is equal to the diameter of the dewatering chamber flange 3. The face of the end cap 30 is machined to meet the tolerance mating requirements of the dewatering chamber flange 3. A dovetail groove 31 is machined into the face of the end cap 30 for, preferentially, an o-ring 32. Inset within the circumference of the end cap 30 is a filter assembly 40. The filter assembly 40 is comprised of a micro porous filtration membrane 41, preferentially a polycarbonate film with pore size of one micron or less, the diameter of membrane 41 equal to the outside diameter of the dewatering chamber 1, a filter support screen 42 of equal diameter, preferentially a woven stainless steel mesh with a five micron particle retention rating, and a rubber gasket 43 of ring construction peripherally binding the membrane 41 to the support screen 42, sealing their edges, and serving as a seal between the end cap 30 and the dewatering chamber 1 during the dewatering cycle. The inside diameter of the gasket 43 is equal to the inside diameter of the dewatering chamber 1. The filter assembly 40 is preferentially affixed to a perforated stainless steel support plate 33 by an epoxy on the surface of the gasket 43 on the support screen 42 side of the filter assembly 40. The support plate 33 has a groove machined along its periphery, the width of the groove equal to the width of the gasket 43 and the depth of the groove equal to the distance between the surface of the support screen 42 and the face of the gasket 43, allowing the support screen 42 to lie flat against the support plate 33. Behind the support plate 33 is a void area bounded by the cylindrical walls of the end cap 30 and the plate which is the face of the end cap nearest the hydraulic cylinder 56 which actuates the end cap 30. A stainless steel cylinder 34 1/20^{th} the diameter of the support plate 33 is centrally affixed to the back of the support plate 33 and extends to the end plate of the end cap, providing additional support against deflection of the support plate 33 during system operation. The cylindrical wall of the void area of the end cap 30 has a vacuum outlet 35 and a drain outlet 36. The vacuum outlet 35, situated 90 degrees from horizontal, is connected to a vacuum hose which is connected to a vacuum pump 51. Preferentially, a vacuum trap is situated in the vacuum line. The drain outlet 36, situated 270 degrees from the horizontal, is connected to a drain valve 45 which permits outflow of the effluent from the dewatering process while maintaining a positive seal against vacuum loss. A coupling 37 is integrated into the face of the end cap 30 end plate for mounting the end cap 30 onto the ram 55 of the hydraulic cylinder 56.

In operation, the sludge dewatering system 100 is automated and controlled by the PLC 66. For preference, the sludge to be dewatered is transferred from the point of generation to an intermediate holding tank. The holding tank is equipped with a float switch that sends a signal to the PLC 66 when there is sufficient sludge to fill the dewatering chamber 1 and commence a dewatering cycle. At the beginning of each dewatering cycle the piston 10 is situated immediately to the rear of the sludge inlet 4 in the chamber 1. If a dewatering cycle is not currently underway, the PLC 66 turns on the hydraulic power unit 20 and energizes the solenoid coil of a hydraulic valve 21 which will commence retraction of the piston 10 away from the discharge end of the chamber 1. At the same time the PLC 66 actuates the ball valve 5 that controls sludge flow into the dewatering chamber 1, opening the valve 5, and the PLC 66 starts the progressing cavity pump 6, filling the dewatering chamber 1 with the sludge. When the piston 10 has fully retracted the face of the piston 10 opposite the sludge contacts a limit switch 60 affixed to the flange 2 of the dewatering chamber 1. The limit switch 60 sends a signal to the PLC 66 indicating the dewatering chamber 1 is full of sludge. The PLC 66 simultaneously de-energizes the previously energized solenoid coil 21, reverses the actuation of the ball valve 5, closing it, and shuts down the progressing cavity pump 6. The PLC 66 then actuates the solenoid coil of the hydraulic valve 21 that controls the extension of the piston 10. The piston 10 begins to traverse axially along the length of the dewatering chamber 1 toward the end cap 30, decreasing the volume of the dewatering chamber 1 and exerting pressure on the sludge, compacting the particulate matter against the filter assembly 40 of the end cap 30 and forcing the effluent into the void area behind the support plate 33, where it drains out of the outlet 36. When the compaction pressure has reached a predetermined point, the first set point of an electrohydraulic pressure switch 23 signals the PLC 66 and the PLC 66 in turn activates the vacuum pump 51. The vacuum pump 51 produces a vacuum in the void area in the end cap 30 to a maximum vacuum of less than 0.007 millibar.

A second set point of the electrohydraulic pressure switch 23 signals the PLC 66 when the maximum operating pressure has been reached. After maximum pressure and vacuum have been maintained for a predetermined length of time, as determined in each individual application by the nature of the sludge being dewatered, but generally less than two minutes, the PLC 66 deactivates the vacuum pump 51 and de-energizes the solenoid coil 21 that controls extension of the piston 10, relieving pressure within the dewatering chamber 1. The PLC 66 then energizes the solenoid coil 22 that controls retraction of the end cap 30, the end cap 30 is fully retracted, and the solenoid coil 22 is de-energized. Next the PLC 66 energizes the solenoid coil 21 to extend the piston 10. The piston 10 extends until the face of the piston 10 is flush with the face of the dewatering chamber flange 3, ejecting the dewatered solids from the chamber 1, and the solenoid coil 21 is de-energized. The solids fall through the cutout in the support plate 80 and into a receptacle, preferentially a drum 90. The PLC 66 energizes the solenoid coil 21 to retract the piston 10, drawing the piston 10 to a position immediately to the rear of the sludge inlet 4, and then de-energizes the coil 21. Then the PLC 66 energizes the coil 22 to extend the end cap 30, driving the end cap 30 flush against the flange 3 of the dewatering chamber 1, and then de-energizes the coil 22. During the dewatering cycle the end cap 30 is restricted from movement by a pilot operated hydraulic check valve 24. The hydraulic cylinders 16, 56 responsible for the motion of the piston 10 and the end cap 30 are equal in chamber bore and operating pressure specifications, so the internal pressure developed by the hydraulic cylinder 56 holding the end cap 30 in place during the dewatering cycle will not exceed manufacturer recommendations. At this point the system is ready to begin the next dewatering cycle.

What is claimed is:

1. A system for the removal of liquid from a liquid/solid matrix, such matrix hereinafter referred to as “sludge”, and the removal of said liquid hereinafter referred to as “dewatering”, comprising:
An enclosure for receiving and dewatering said sludge, said enclosure comprising;
A chamber within which said sludge is contained,
A movable piston within said chamber functioning as a wall of said enclosure,
A movable end cap functioning as a wall of said enclosure opposite said piston.

2. A system according to claim 1 wherein said chamber has incorporated an inlet for said sludge prior to dewatering.

3. A system according to claim 1 wherein said piston is driven mechanically and capable of reciprocation throughout the length of said chamber, said piston functioning to mechanically compress said sludge and to eject said sludge from the end of said chamber at the conclusion of the dewatering process.

4. A system according to claim 1 wherein said end cap is driven mechanically and capable of reciprocation to effect closing of said chamber for dewatering and opening of said chamber for the discharge of the dewatered sludge, said end cap having incorporated an outlet for the liquid removed from said sludge.

5. A system according to claim 4 wherein said end cap has incorporated an outlet for connection to a vacuum source.

6. A system according to claim 4 wherein a perforated support structure is incorporated within said end cap.

7. A system according to claim 6 wherein a filter assembly is affixed to said support structure within said end cap.

8. A system according to claim 7 wherein said filter assembly consists of a primary porous membrane and a secondary support membrane of greater porosity than the primary membrane, two said membranes peripherally bound by a gasket, said gasket functioning as a seal between said end cap and said enclosure.

9. A system according to claim 1 further comprising:
A means for driving said piston;
A means for driving said end cap;
A means for filling said chamber with said sludge;
A means for automation of the dewatering process:
A means of alignment and support of said enclosure, the means of driving said piston and the means of driving said end cap.

10. A system according to claim 9 further comprising a means for producing a vacuum within said end cap.

11. A system according to claim 9 wherein said means of automation incorporates a limit switch to detect the position of said piston when said chamber is full of said sludge.

12. A system according to claim 9 wherein said means of automation incorporates a programmable logic controller.

13. A system according to claim 12 wherein said programmable logic controller has incorporated a software program for system automation.

14. A system according to claim 9 wherein said means of alignment and support are aligned along a horizontal axis.
